(19) United States
(12) Patent Application Publication
(10) Pub. No.: US 2019/0391891 A1
(43) Pub. Date: Dec. 26, 2019

(54) NON-INTRUSIVE, LIGHTWEIGHT MEMORY ANOMALY DETECTOR

(71) Applicant: CA, Inc., New York, NY (US)

(72) Inventors: Smrati Gupta, San Jose, CA (US); Anil Maipady, Santa Clara, CA (US)

(21) Appl. No.: 16/013,699

(22) Filed: Jun. 20, 2018

(51) Int. Cl. G06F 11/22; G06N 3/08; G06N 3/04

(52) U.S. Cl. CPC G06F 11/2263; G06N 3/0436; G06N 3/08

(57) ABSTRACT

A lightweight, non-intrusive memory anomaly detector has been designed that focuses on time sub-windows in the time-series data for selected memory related metrics that can efficiently be collected by probes or agents without being intrusive with the virtual machines (VMs) being monitored. In addition, the memory anomaly detector extracts features from those sub-windows of correlated features to present a smaller input vector to two classifiers: a fuzzy rule-based classifier and an artificial neural network. This allows the memory anomaly detector to be “lightweight” because it is less computationally expensive to run a smaller artificial neural network. The fuzzy rule-based classifier applies fuzzy rules to the input vector and provides classification labels, which are used to train an artificial neural network (ANN). After being trained, the trained ANN is refined with supervised feedback and presents its output of classification probabilities for application performance analysis.

### BACKGROUND

The disclosure generally relates to the field of data processing, and more particularly to artificial intelligence.

Application performance management (APM) involves the collection of numerous metric values for an application. For a distributed application, an APM application or tool will receive these metric values from probes or agents that are deployed across application components to collect the metric values and communicate them to a repository for evaluating. The collected metric values are monitored and analyzed to evaluate performance of the application, detect anomalous behavior, and inform root cause analysis for anomalous behavior.

Many anomalies in application performance relate to memory management. One type of memory related anomaly is a memory leak. A memory leak is a scenario in which memory is incorrectly managed for a program or application. In the context of a Java® Virtual Machine (JVM), a memory leak occurs when objects that are no longer used by an application are still referenced. Since the objects are still referenced, the JVM garbage collector cannot free the corresponding despite the objects not being used by an application. If unresolved, less memory will be available and pauses for garbage collection will increase in frequency. These will incur performance penalties on the application running within the JVM.

### BRIEF DESCRIPTION OF THE DRAWINGS

Embodiments of the disclosure may be better understood by referencing the accompanying drawings.

FIG. 1 is a conceptual diagram of a non-intrusive, lightweight memory anomaly detector.

FIG. 2 is a conceptual diagram of the lightweight anomaly detector 101 after the artificial neural network has been trained by the fuzzy rule-based classifier.

FIG. 3 is a flowchart of example operations for multi-phase memory anomaly detection with an artificial neural network and a fuzzy rule-based classifier.

FIG. 4 is a flowchart of example operations for extracting features from a time-series dataset of memory related metrics for an application to create the memory anomaly feature vector.

FIG. 5 depicts an example computer system with a lightweight memory anomaly detector.

### DESCRIPTION

The description that follows includes example systems, methods, techniques, and program flows that embody embodiments of the disclosure. However, it is understood that this disclosure may be practiced without these specific details. In other instances, well-known instruction instances, protocols, structures and techniques have not been shown in detail in order not to obfuscate the description.

### INTRODUCTION

A monitoring component of an APM application will likely use threshold alarms or univariate statistical analysis to detect memory anomalies. With a memory anomaly, such as a memory leak, there is not “one right” metric to monitor in order to detect a memory anomaly. Since multiple metric would be monitored, a machine-learning based multivariate pattern recognition can be used to detect memory anomalies. This would be a heavy solution since feeding in a stream of time-series data across multiple metrics into a machine learning algorithm would be computationally expensive. In addition, the monitoring component would be intrusive because it would be programmed to interface with the JVM to obtain the metric values or access JVM instrumentation counters. If JVM instrumentation counters are maintained in temporary files, then the monitoring component can access the temporary file and avoid interfacing with the JVM. However, the monitoring component would search the file for information about garbage collection operations. This would add latency overhead.

Overview

A memory anomaly detector has been designed that is lightweight and non-intrusive. The lightweight, non-intrusive memory anomaly detector has been designed to extract features for classification by a rule-based classifier until a second classifier has been trained by the rule-based classifier. The memory anomaly detector correlates values in time-series data for selected memory related metrics (“correlated features”). This data can be efficiently collected by probes or agents without being intrusive with the application component (e.g., virtual machines (VMs)) being monitored. In addition, the memory anomaly detector derives additional features from the correlated values to present a smaller input vector to the two classifiers: a fuzzy rule-based classifier and an artificial neural network. This allows the memory anomaly detector to be “lightweight” because it is less computationally expensive to run a smaller artificial neural network. The fuzzy rule-based classifier applies fuzzy rules to the input vector and provides classification labels. The classification labels indicate a first probability/confidence that the input vector represents a pattern(s) that can be classified as a memory anomaly and a second probability/confidence that the input vector represents a pattern than can be classified as canonical memory behavior (i.e., not a memory anomaly). In addition to the fuzzy rule-based classifier providing output for application performance analysis, the input vector and labels used to train the artificial neural network (ANN). After being trained, the trained ANN is refined with supervised feedback (e.g., administrator or triage feedback) and presents its output of classification probabilities for application performance analysis.

Example Illustrations

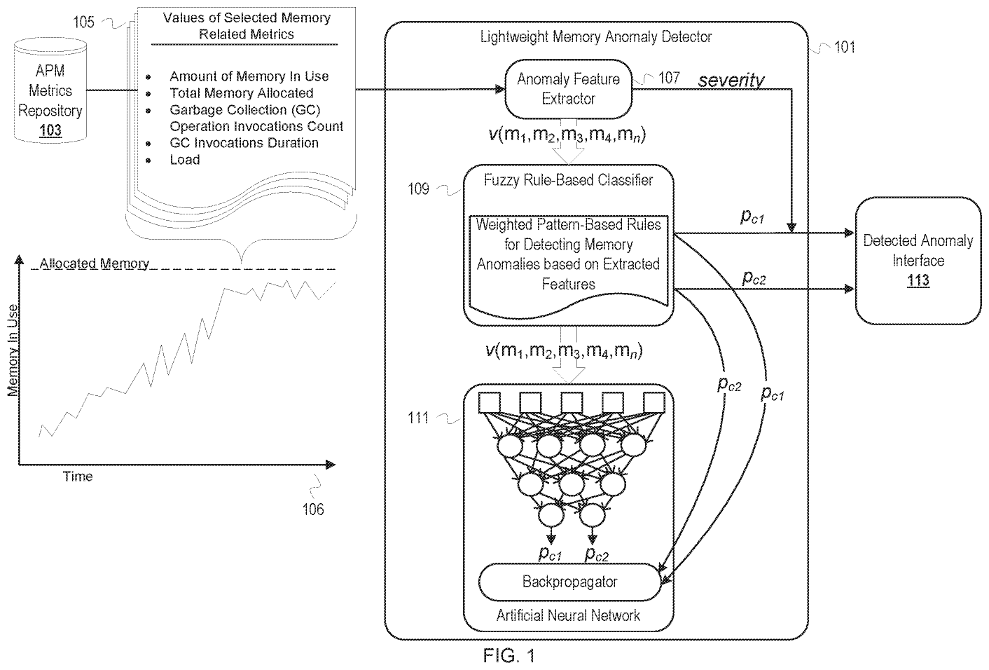

FIG. 1 is a conceptual diagram of a non-intrusive, lightweight memory anomaly detector. A lightweight memory anomaly detector 101 is in communication with an application performance management (APM) metric repository 103. The lightweight memory anomaly detector 101 (“detector”) uses classifiers to detect memory anomalies and outputs detected memory anomalies to a detected anomaly interface 113. The detected anomaly interface 113 can be an application or application component for monitoring an application and analyzing anomalous behavior of an application.

Probes or agents of an APM application will collect values of application metrics and store the collected metric values into the repository 103. The collected metric values are time-series data forming a time-series dataset because the collection is ongoing and the metric values are associated with timestamps. The repository 103 is hierarchically structured or at least indicates hierarchical relationships of the application components and corresponding metrics. The detector 101 is configured to obtain time-series values of metrics related to memory management. In this example, the detector 101 is configured to obtain time-series values of metrics for garbage collection operations of virtual machines. A distributed application can have multiple virtual machines that instantiate and terminate over the life of the distributed application. Thus, the detector 101 may be scanning several containers (e.g., folders or stores) or key-value entries that correspond to different virtual machines.

For each of these monitored virtual machines the memory management related metrics include total memory allocated to the VM, memory in use by the VM, counts of invocations of garbage collection operations (e.g., marksweep, scavenge, etc.), and duration of garbage collection operations. These memory management related metrics do not involve transaction traces or calling a Java® function to obtain the metric values, such as object age or number of created objects. Instead, probes obtain these metric values non-intrusively instead of. In addition to the memory management related metrics of each VM, the detector 101 obtains time-series values for the load on the application or application component supported by the VM. Disregarding interruptions and restarts of the application, the detector 101 continuously obtains these time-series values. Time-series values for these metrics for a time period is represented by the stack of time-series data 105. A graph 106 represents the memory in use over time as indicated in the time-series data 105. The graph 106 illustrates that the memory in use for a virtual machine (or aggregate of virtual machines) is approaching the allocated memory limit for the virtual machine, which would be anomalous behavior.

In FIG. 1, the functionality of the detector 101 has been logically organized into an anomaly feature extractor 107, a fuzzy rule-based classifier 109, and an artificial neural network (ANN) 111. Each of these are likely implemented as different code units (e.g., functions or subroutines), but implementation specifics can vary by developer, language, platform, etc. The anomaly feature extractor 107 extracts memory anomaly features from the time-series dataset 105 by reducing the size of input to be supplied to the fuzzy rule-based classifier 107 and the ANN 111 and by deriving memory anomaly features from one or more metrics indicated in the time-series dataset 105. To reduce the size of input, the anomaly feature extractor 107 uses the metric garbage collection (GC) operation invocations to exclude values of other metrics from consideration. The GC operation invocations will only occur at particular times across the time span corresponding to the time-series dataset 105. Accordingly, the GC operation invocations will be associated with fewer timestamps or time instants than included in the time-series dataset 105. To focus the analysis (i.e., reduce the input size for analysis by the classifiers), the anomaly feature extractor 107 selects values of other metrics that correlate with the GC operation invocations by time. The margin size is a configured value of the anomaly feature extractor 107. With the correlated metric values or across all memory in use values in the dataset 105, the anomaly feature extractor 107 derives other features, such as incremental slopes and a net slope of memory in use and GC operation durations. The anomaly feature extractor 107 also computes a severity value based on allocated memory and memory in use. The severity value represents how quickly the memory in use is approaching the allocated memory. The anomaly feature extractor 107 can supply the severity value to the detected anomaly interface 113 directly or pass it through the fuzzy rule-based classifier 109. The anomaly feature extractor 107 assembles the extracted features into an input vector represented as v(m₁, m₂, m₃, m₄, mₙ), which flows to the fuzzy rule-based classifier 109.

The fuzzy rule-based classifier 109 is a set of rules for pattern-based detection of memory anomalies. The rules are weighted. The weights of breached or satisfied rules are aggregated into probabilities or confidence values associated with corresponding labels of a first classification “anomaly” and a second classification “no anomaly.” The weights and rules have been created based on expert knowledge of the application's behavior with respect to these memory management related metrics. As examples, a first rule may be that if the memory in use slope represents a rate of increase within a range of 12%-20% and load is not increasing during that same time sub-window, then the label “anomaly” is associated with a confidence value of 0.3. Confidence values associated with other “anomaly” rules would be aggregated with the 0.3. Similarly, rules corresponding to canonical behavior of the application's memory management metrics would be evaluated and have confidence weights are aggregated for satisfied rules to be associated with the label “no anomaly.” Finally, the fuzzy rule-based classifier 107 generates a confidence/probability value for the first classification label “anomaly” (depicted as psi) and for the second classification label “no anomaly” (depicted as p_{c2}). The fuzzy rule-based classifier 107 supplies the generated values to the detected anomaly interface 113. The fuzzy rule-based classifier 107 also supplies the generated values to the ANN 111 along with the input vector of extracted features for training.

The detector 101 trains the ANN 111 with the output from the fuzzy rule-based classifier. The ANN 111 forward feeds the input vector of extracted features through the connected neurons of ANN 111 and produces probabilities of the different classifications of “anomaly” and “no anomaly,” which is also depicted as p_{c1} and p_{c2} from the output layer of the ANN 111. A backpropagator of the ANN 111 then runs a back propagation algorithm with the output values from the fuzzy rule-based classifier 107 and the output layer of the ANN 111 to determine variance and adjust the bias or weights of the ANN 111. This training of the ANN 111 with output from the fuzzy rule-based classifier 107 continues until a specified training threshold (e.g., number of training vectors or training set size) is satisfied.

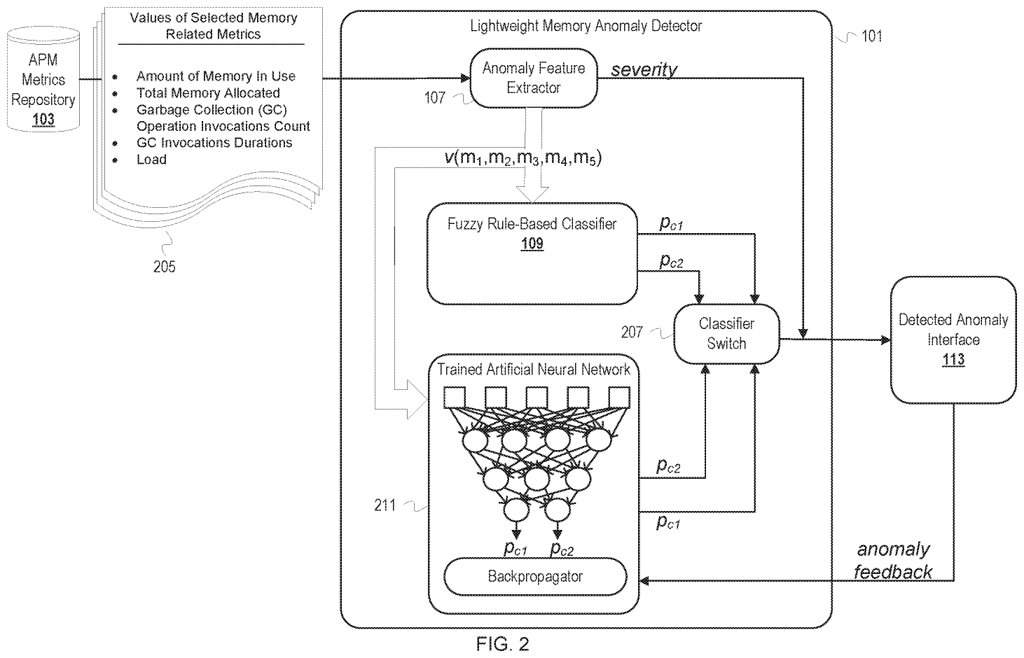

FIG. 2 is a conceptual diagram of the lightweight anomaly detector 101 after the artificial neural network has been trained by the fuzzy rule-based classifier. In FIG. 2, the ANN 111 has been trained and is now referred to as trained ANN 211. Extracted features input vectors from the anomaly feature extractor 107 are depicted as flowing directly to the trained ANN 211 instead of through the fuzzy rule-based classifier 109. The input vectors can flow directly (e.g., be directly passed as arguments in an invocation) to the ANN 111 while the ANN is being trained. In that case, the detector 101 would coordinate processing of the input vector by the ANN 111 with the output of the fuzzy rule-based classifier 109 to ensure the correct output is being used for backpropagation. FIG. 2 depicts a time-series dataset 205 for a different time span than in FIG. 1 since the ANN 111 has been trained, resulting in the trained ANN 211.

After training completes, the trained ANN 211 and the fuzzy rule-based classifier 109 output probabilities of the different classifications of anomaly versus no anomaly to a classifier switch 207. The classifier switch 207 evaluates the values output from the two classifiers 109, 211 to determine when the trained ANN 211 deviates from the classifier 109. When the trained ANN 211 deviates from the classifier 109, the switch 207 selects the output from the trained ANN 211 for communicating to the detected anomaly interface 113. If feedback indicates that the output of the fuzzy-rules based classifier 109 was incorrect, then the switch 207 can also switch to the ANN 211. The trained ANN 211 will eventually deviate from the classifier 109 because the trained ANN 211 is receiving anomaly feedback detected anomaly interface 113. The trained ANN 211 revises itself based on this feedback, which allows the trained ANN 211 to further adapt to behavior of the application being monitored. Behavior of an application can vary based on deployment attributes (e.g., computational resources, governing policies, infrastructure, etc.). Although not depicted in FIGS. 1 and 2, the classifiers likely output the extracted feature vector to the interface 113 to provide contextual data for the classifications and probabilities.

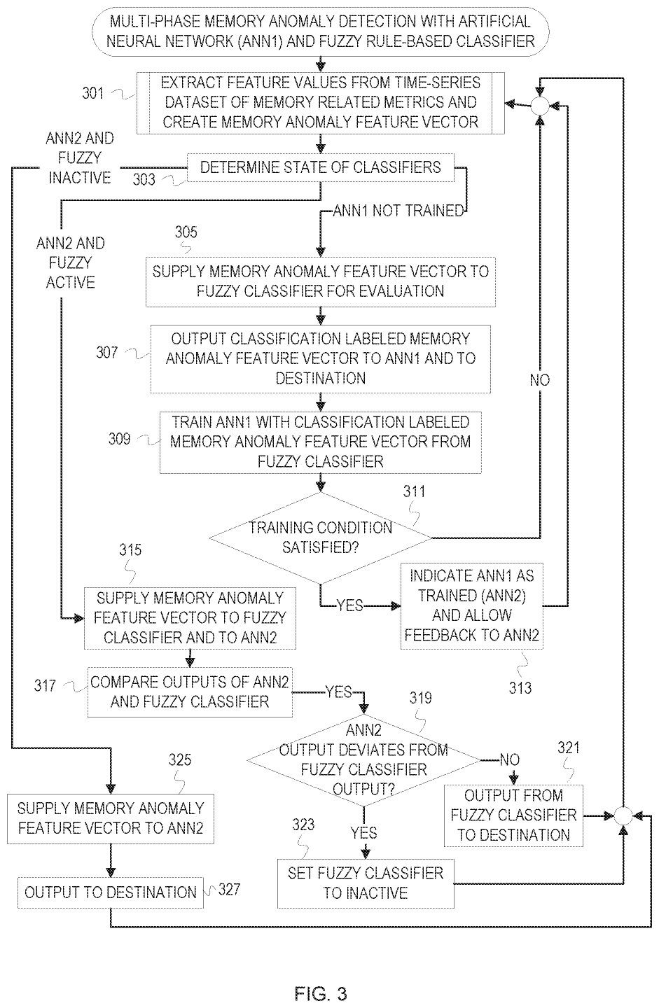

FIG. 3 is a flowchart of example operations for multi-phase memory anomaly detection with an artificial neural network and a fuzzy rule-based classifier. The description of the example operations refers to a detector as performing the operations. The example operations encompass a first phase in which the fuzzy rule-based classifier communicates memory anomaly detection classifications with probability values to a destination for analysis as part of monitoring and managing performance of an applications. During this first phase, the outputs of the fuzzy rule-based classifier are also used to train the ANN until the ANN takes over in a second phase.

A lightweight memory anomaly detector extracts memory anomaly related feature values from a time-series dataset of memory related metrics for a virtual machine of an application (301). The time-series dataset has time-series values for different metrics. Examples of the metrics include application load, memory allocated to the virtual machine, memory in use by the virtual machine, GC operation invocations, and GC operation duration. The GC operation metrics may exist for different types of GC operations. With the extracted feature values, the detector creates a memory anomaly feature vector.

The lightweight memory anomaly detector determines states of the two classifiers: the fuzzy rule-based classifier and the ANN (303). If the ANN has not yet been indicated as trained, then the detector proceeds to supplying the memory anomaly feature vector as input to the fuzzy rule-based classifier for evaluation (305). Based on the fuzzy rule-based classifier applying the weighted pattern-based rules to the memory anomaly feature vector, the fuzzy rule-based classifier outputs a classification labeled memory anomaly feature vector to the untrained ANN (ANN1) and the destination that has been specified to the detector (e.g., in a configuration, a request message, etc.) (307). The classification labeled memory anomaly feature vector is the memory anomaly feature vector associated with the labels corresponding to anomaly and no anomaly as well as the corresponding probabilities or confidence values. This can be implemented with a data structure chosen by the developer.

With the output from the fuzzy rule-based classifier, the ANN1 trains itself (309). The components of the extracted memory anomaly feature vector will be input into the ANN1 and feed forward until probability outputs are produced by the output layer. Backpropagation then revises the internal weights based on the probability values from the fuzzy classifier.

Before a next extracted memory anomaly feature vector is fed to the ANN1, the detector determines whether a training condition has been satisfied (311). A training condition can be threshold specified in various terms. Examples of the training condition threshold include number of input vectors, number of training runs, and time period of data. This is chosen based on an expectation of when the ANN1 will converge with the fuzzy rule-based classifier. If the training size threshold has not been satisfied, then the detector proceeds to process the next time-series dataset. If the training size threshold has been satisfied, then the detector indicates that the ANN1 has been trained (and is now referred to as ANN2) and allows feedback to be supplied to ANN2 (313). This feedback can be obtained from a user interface that allows a user to indicate whether behavior of an application component (e.g., a virtual machine) as represented by a vector of extracted feature values corresponds to anomalous behavior related to memory use/management.

An optional phase allows for the fuzzy rule-based classifier to continue being active with ANN2 and still provide outputs to the destination. Since ANN2 has been trained by the fuzzy rule-based classifier, it should produce the same outputs. However, feedback to ANN2 causes revisions to ANN2 that will eventually cause ANN2 to diverge from the fuzzy rule-based classifier. When the detector determines that both ANN2 and the fuzzy rule-based classifier are active (303), the detector supplies the memory anomaly feature vector to both classifiers (317). The detector compares the outputs of both classifiers (317) to determine whether ANN2 is deviating from the fuzzy rule-based classifier. If ANN2 deviates, then the detector sets the fuzzy rule-based classifier to inactive (323). Otherwise, the detector selects the classification labeled memory anomaly feature vector from the fuzzy classifier to output to the destination (321).

When the detector determines that ANN2 is active but the fuzzy rule-based classifier is inactive (303), the detector supplies the memory anomaly feature vector to ANN2 (325). The fuzzy rule-based classifier is no longer used because it has not adapted to the behavior of the application. The detector then outputs to the destination the probabilities for each class from the ANN2 and the memory anomaly feature vector the destination.

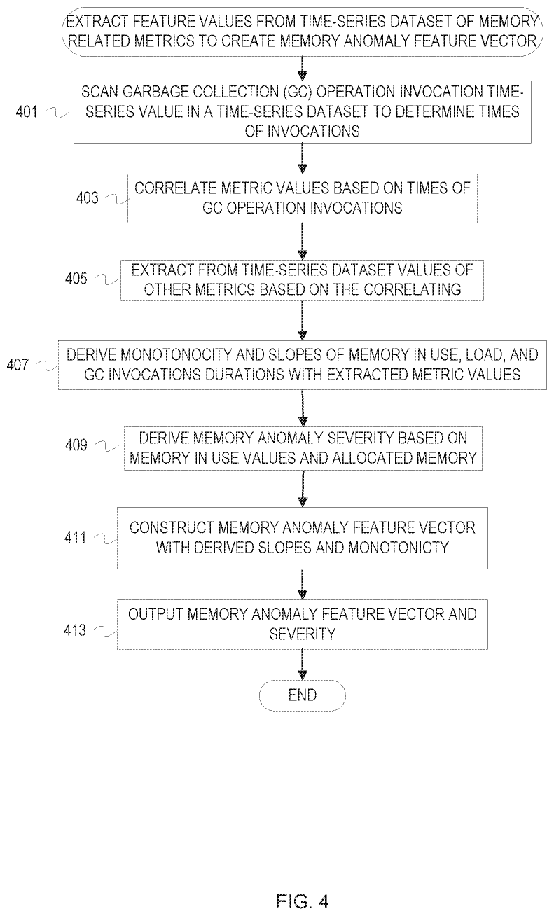

FIG. 4 is a flowchart of example operations for extracting feature values from a time-series dataset of memory related metrics for an application to create the memory anomaly feature vector. The example operations of FIG. 4 are an example implementation for 301 in FIG. 3. The description of FIG. 4 refers to an extractor as performing the example operations.

The extractor scans GC operation invocation time-series values in the time-series dataset to determine times of GC operation invocations (401). The extractor searches through the GC operation invocation time-series values for non-zero values to track the associated times of those invocations. In some cases, the time-series values for GC operation invocations may not include zero values (i.e., not include times when GC operations were not invoked). For those cases, the extractor can track the times indicated in the GC operation invocation time-series values.

Based on the identified times of GC operation invocations, the extractor correlates values of other metrics (403). The extractor determines values in the time-series values of other metrics in the time-series dataset at the times of the GC operations invocations. Since the impact of the GC operation invocations upon other metrics do not necessarily align at the same time, the extractor can determine time sub-windows based on the GC operation invocation times and a defined time margin (e.g., 5% of an interval size or 5 seconds). A single time margin can be applied across metrics or at least some metrics can have specific time margins.

The extractor then extracts from the time-series dataset values of the other metrics based on the correlating (405). The extractor can mark or record the values that occur at the same times as the GC operation invocations and/or within the time sub-windows determined by the extractor.

The extractor uses the extracted time-series values to derive monotonicity and slopes (407). The extractor can derive a net slope of memory in use across the time span corresponding to the time-series dataset based on the memory in use values extracted based on the correlating. The extractor can also determine incremental slopes based on the time-series memory in use values extracted based on the correlated. The extractor can also derive these slopes for other metrics, such as load values and the extracted GC operations duration values. The slopes and monotonicity are considered the features for memory anomaly detection by the classifiers. The extractor also derives a severity of memory anomaly based on the extracted memory in use values and extracted allocated memory values (409).

The extractor constructs a memory anomaly feature vector with the extracted features (411). The extracted feature values include the derived values that were determined from the time-series values extracted based on the correlating, although severity is not included in the vector. The extractor then outputs the memory anomaly feature vector and the severity value.

Variations

The example illustrations above describe an intermediate phase in which an output is chosen from the trained neural network and the fuzzy rule-based classifier. Embodiments do not necessarily have this intermediate phase and can, instead, deactivate the fuzzy rule-based classifier after the neural network has been trained with the specified training data size.

The example illustrations also describe deriving features based on values extracted based on time correlation across metrics from the GC operation invocation metric. This is done based on an assumption that a local minima and local maximum can be found for the time or time sub-window being used for correlation. Embodiments can derive the slope and monotonicity features across the time-series values of the time-series dataset without reducing the values by correlation. This may burden the compute resources used for extracting, but the classifiers will still be focused on the derived features.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, the operations depicted in blocks 315, 317, and 318 are not necessary. A detector can deactivate the fuzzy rule-based classifier after the training size threshold for the artificial neural network has been satisfied. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language; a dynamic programming language; a scripting language; and conventional procedural programming languages. The program code may execute entirely on a stand-alone machine, may execute in a distributed manner across multiple machines, and may execute on one machine while providing results and or accepting input on another machine.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

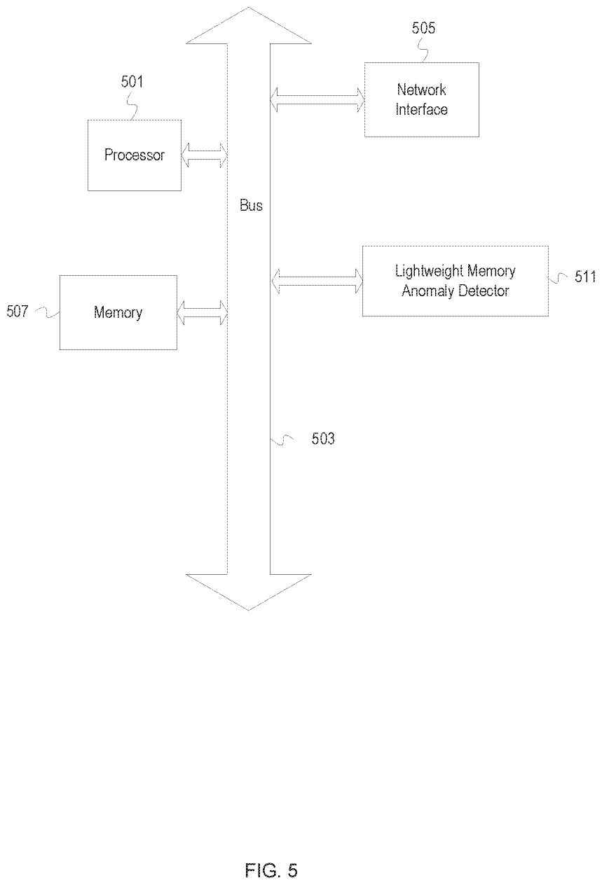

FIG. 5 depicts an example computer system with a lightweight memory anomaly detector. The computer system includes a processor unit 501 (possibly including multiple processors, multiple cores, multiple nodes, and/or implementing multi-threading, etc.). The computer system includes memory 507. The memory 507 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 503 (e.g., PCI, ISA, PCI-Express, HyperTransport® bus, InfiniBand® bus, NuBus, etc.) and a network interface 505 (e.g., a Fiber Channel interface, an Ethernet interface, an internet small computer system interface, SONET interface, wireless interface, etc.). The system also includes a lightweight memory anomaly detector 511. The lightweight memory anomaly detector 511 can generate classification probabilities for an application's behavior as represented by memory management related metrics from a rule-based classifier while training an artificial neural network. This allows the detector to provide useful insight into application behavior as related to memory anomalies while the artificial neural network trains. Once the artificial neural network has been trained with a specified training set size, the artificial neural network can consume feedback that allows it to adapt to memory behaviors of the application not addressed by the fuzzy rule-based classifier. Any one of the previously described functionalities may be partially (or entirely) implemented in hardware and/or on the processor unit 501. For example, the functionality may be implemented with an application specific integrated circuit, in logic implemented in the processor unit 501, in a co-processor on a peripheral device or card, etc. Further, realizations may include fewer or additional components not illustrated in FIG. 5 (e.g., video cards, audio cards, additional network interfaces, peripheral devices, etc.). The processor unit 501 and the network interface 505 are coupled to the bus 503. Although illustrated as being coupled to the bus 503, the memory 507 may be coupled to the processor unit 501.

While the aspects of the disclosure are described with reference to various implementations and exploitations, it will be understood that these aspects are illustrative and that the scope of the claims is not limited to them. In general, techniques for non-intrusive, lightweight memory anomaly detection as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

What is claimed is:

1. A method comprising:
deriving first values of a plurality of features for a time-series dataset for an application, wherein the time-series dataset includes multiple time-series values for multiple metrics corresponding to memory management of the application;
training an artificial neural network with the derived first values and with classification output generated from a fuzzy rule-based classifier based on the first values, wherein the classification output of the fuzzy rule-based classifier is also used for memory anomaly detection for the application; and
based on satisfying a training condition for the artificial neural network, inputting derived features of subsequent time-series datasets for the application into the artificial neural network for detecting memory anomalies and allowing feedback to the artificial neural network for revising the artificial neural network.

2. The method of claim 1 further comprising deactivating the fuzzy rule-based classifier after the training condition has been satisfied.

3. The method of claim 2, further comprising:
based on satisfying the training condition, comparing classification outputs of the artificial neural network and the fuzzy rule-based classifier to determine whether the classification outputs deviate from each other, wherein the classification outputs are based on second values of the plurality of features for a subsequent time-series dataset for the application,
wherein deactivating the fuzzy rule-based classifier is based on detecting a deviation between the classification outputs.

4. The method of claim 1, wherein the plurality of features comprises slopes and monotonicity for at least a subset of the multiple metrics.

5. The method of claim 1, wherein deriving the first values for the plurality of features comprises correlating values of a first metric with values of others of the multiple metrics based on times of the values of the first metric.

6. The method of claim 5, wherein correlating values of the first metric with values of others of the multiple metrics comprises determining time sub-windows from the times of the values of the first metric and a defined time margin and selecting the values in the time-series values of the other metrics within the time sub-windows.

7. The method of claim 5, wherein the first metric comprises garbage collection operation invocations.

8. The method of claim 1, wherein the multiple metrics comprise amount of memory in use, memory allocated, garbage collection operation invocation, garbage collection operation invocation duration, and load on the application.

9. The method of claim 1, wherein the multiple metrics correspond to a virtual machine of the application and to different types of garbage collection operations.

10. A non-transitory, computer-readable medium having instructions stored thereon that are executable by a computing device to perform operations comprising:
deriving first values of a plurality of features for a time-series dataset for an application, wherein the time-series dataset includes multiple time-series values for multiple metrics corresponding to memory management of the application;
training an artificial neural network with the derived first values and classification output generated from a fuzzy rule-based classifier based on the first values, wherein the classification output of the fuzzy rule-based classifier is also used for memory anomaly detection for the application; and
based on satisfying a training condition for the artificial neural network, inputting derived features of subsequent time-series datasets for the application into the artificial neural network for detecting memory anomalies and allowing feedback to the artificial neural network for revising the artificial neural network.

11. The non-transitory, computer-readable medium of claim 10 further comprising instructions executable by a computing device to perform operations comprising deactivating the fuzzy rule-based classifier after the training condition has been satisfied.

12. The non-transitory, computer-readable medium of claim 11, further comprising instructions executable by a computing device to perform operations comprising:
based on satisfying the training condition, comparing classification outputs of the artificial neural network and the fuzzy rule-based classifier to determine whether the classification outputs deviate from each other, wherein the classification outputs are based on second values of the plurality of features for a subsequent time-series dataset for the application,
wherein deactivating the fuzzy rule-based classifier is based on detecting a deviation between the classification outputs.

13. The non-transitory, computer-readable medium of claim 10, wherein the plurality of features comprises slopes and monotonicity for at least a subset of the multiple metrics.

14. The non-transitory, computer-readable medium of claim 10, wherein deriving the first values for the plurality of features comprises correlating values of a first metric with values of others of the multiple metrics based on times of the values of the first metric.

15. The non-transitory, computer-readable medium of claim 14, wherein correlating values of the first metric with values of others of the multiple metrics comprises determining time sub-windows from the times of the values of the first metric and a defined time margin and selecting the values in the time-series values of the other metrics within the time sub-windows.

16. The non-transitory, computer-readable medium of claim 14, wherein the first metric comprises garbage collection operation invocations.

17. The non-transitory, computer-readable medium of claim 10, wherein the multiple metrics comprise amount of memory in use, memory allocated, garbage collection operation invocation, garbage collection operation invocation duration, and load on the application.

18. The non-transitory, computer-readable medium of claim 10 further having instructions executable by a computing device to perform operations comprising generating an event comprising a classification output from the artificial neural network model while the training condition is satisfied.

19. An apparatus comprising:
a processor; and
a computer-readable medium having program code executable by the processor to cause the apparatus to,
derive first values of a plurality of features for a time-series dataset for an application, wherein the time-series dataset includes multiple time-series values for multiple metrics corresponding to memory management of the application;
train an artificial neural network with the derived first values and classification output generated from a fuzzy rule-based classifier based on the first values, wherein the classification output of the fuzzy rule-based classifier is also used for memory anomaly detection for the application; and
based on satisfying a training condition for the artificial neural network, input derived features of subsequent time-series datasets for the application into the artificial neural network for detecting memory anomalies and allowing feedback to the artificial neural network for revising the artificial neural network.

20. The apparatus of claim 19, wherein the computer-readable medium further has program code executable by the processor to cause the apparatus to generate an event indicating the classification output from the fuzzy rule-based classifier while the training condition is not satisfied and to generate an event indicating classification output from the artificial neural network when the training condition is satisfied.
